(19) United States
(12) Patent Application Publication
(10) Pub. No.: US 2015/0112855 A1
(43) Pub. Date: Apr. 23, 2015

(54) Parent and Child Account Relationship

(71) Applicant: Network Enhanced Telecom, LLP, Longview, TX (US)

(72) Inventors: Karthik Srinivasan, Chandler, AZ (US); Lon Nix, Austin, TX (US); Ryan Kendrick, Austin, TX (US); Steven Wood, Austin, TX (US); Ryan Perez, Longview, TX (US)

(73) Assignee: Network Enhanced Telecom, LLP, Longview, TX (US)

(21) Appl. No.: 14/057,943

(22) Filed: Oct. 18, 2013

(51) Int. Cl. G06Q 20/10

(52) U.S. Cl. CPC G06Q 20/10
USPC 705/39

(57) ABSTRACT

The present disclosure involves enabling a parent and child account relationship. One example method includes identifying a child account associated with a parent account, the parent account including a monetary amount, the child account being different than the parent account; identifying a communication associated with the child account; transferring at least a portion of the monetary amount from the parent account to the child account after identifying the communication associated with the child account; and debiting the portion of the monetary amount in the child account for charges associated with the communication.

### TECHNICAL FIELD

The present application generally relates to communications, and more specifically, to a relationship between parent and child accounts in which a portion of the parent balance is transferred from the parent account to the child account when the child account is used for a communication.

### BACKGROUND

Communication services are generally provided to holders of accounts. In some cases, the accounts are associated with a balance or monetary value that is used to pay for any charges accrued while using the communication service. Generally, the balance associated with the account will be debited for the accrued charges, and if the account does not have sufficient funds to cover additional charges, the communication service will be terminated.

### SUMMARY

The present disclosure involves systems, software, and computer implemented methods for enabling a parent and child account relationship. One computer-implemented method includes identifying a child account associated with a parent account, the parent account including a monetary amount, the child account being different than the parent account; identifying a communication associated with the child account; transferring at least a portion of the monetary amount from the parent account to the child account after identifying the communication associated with the child account; and debiting the portion of the monetary amount in the child account for charges associated with the communication.

While generally described as computer-implemented software embodied on non-transitory, tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

Prepaid communication services generally apply charges accrued during a communication, such as a telephone call, to an account associated with the communication. The account may be associated with a personal identification number (PIN) and used by the account holder to identify the account. Generally, when the balance on a prepaid account is exhausted, any associated communications will end. Furthermore, each account is generally independent from other accounts, and its balance is kept separate from the balances of other accounts.

In some cases, it may be advantageous to allow an account to share the balance of a “parent account.” For example, a business may wish to maintain a single balance or credit limit for all of its long distance usage to efficiently manage cost but issue a separate account to each employee to track individual usage. One possible approach would be to associate multiple PINs to a single account, and allow multiple simultaneous communications to occur. One problem with this approach is the inability to reliably indicate an amount of the communication service that may be obtained using the balance. For example, if a second PIN is used to access the account while a communication using a first PIN is active, the balance on the account will now be depleted at a different rate as compared to when only one pin is actively used thereby rendering any estimate service usage remaining associated with the first PIN inaccurate. This may be important for prepaid services where an amount of time based on the balance is announced to a user at the beginning of a communication (e.g., a prepaid phone call). The present disclosure describes various techniques for coordinating simultaneous communications sharing a balance through a parent/child paradigm that controls and monitors transfer of funds between accounts.

### BRIEF DESCRIPTION OF THE DRAWINGS

FIG. 1 shows an example environment for enabling a parent-child account relationship.

FIG. 2 shows a message flow diagram illustrating an interaction between components for enabling a parent-child account relationship.

FIG. 3 shows an example interface for configuring a parent account.

FIG. 4 shows an example interface for configuring a child account.

FIG. 5 shows an example method for enabling a relationship between a parent account and a child account

### DETAILED DESCRIPTION

The present application generally relates to communications, and more specifically to a relationship between parent and child accounts in which a portion of the parent balance is transferred from the parent account to the child account when the child account is used for a communication.

Prepaid communications services generally apply charges accrued during a communication, such as a telephone call, to an account associated with the communication. The account may be associated with a personal identification number (PIN) and used by the account holder to identify the account. Generally, when the balance on a prepaid account is exhausted, any associated communications will end. Further, each account is generally independent from other accounts, and its balance is kept separate from the balances of other accounts.

In some cases, it may be advantageous to allow an account to share the balance of a “parent account.” For example, a business may wish to maintain a single balance for all its long distance usage, but issue a separate account to each employee so individual usage may be tracked. One possible approach would be to associate multiple PINS to a single account, and allow multiple simultaneous communications to occur. One problem with this approach is the inability to reliably indicate an amount of the communication service that may be obtained using the balance. For example, if a second PIN is used to access the account while a communication using a first PIN is active, the balance will now be depleted at a different rate as compared to when only one pin is actively used thereby rendering any estimate service usage remaining associated with the first PIN inaccurate. This may be important for prepaid services where an amount of time based on the balance is announced to a user at the beginning of a communication (e.g., a prepaid phone call).

In some implementations, the present solution may allow for simultaneous access by multiple users to an account balance while avoiding the problems of the approaches discussed above. The solution may involve designating an account including a balance as a parent account, and designating other accounts to be used to access the balance as child accounts. When a communication is initiated using one of the child accounts, a portion of the parent account balance may be transferred to the child account, and added to the balance associated with the child. The communication then proceeds, and any accrued charges are debited from the child account balance. When the communication ends, the child account balance may be transferred back to the parent account, such that the child account is left with a zero or nominal balance at the conclusion of the communication.

In some implementations, the present solution may be used in a prepaid telecommunications scenario. For example, a caller may initiate a phone call to a prepaid telecommunications system and enter a PIN corresponding to a child account. A corresponding parent account for the child account may be identified. A certain amount of funds may then be transferred to the child account from the parent account for use during the phone call. The amount of funds may then be announced to the caller. The caller may then place a call to a destination. During the call, charges may be debited from the child account balance. When the caller is finished with the call, the caller may hang up to end the call. When the call ends, the remaining balance on the child account may be automatically transferred back to the parent account.

In some implementations, if the child account's balance is exhausted during the communication, an additional transfer of funds from the parent account to the child account may be performed. Referring again to the prepaid telecommunications example, if the child account's balance drops below a certain threshold during the phone call due to the accrued charges for the call being debited from the balance, an additional amount may be transferred from the parent account for use on the call. This avoids the phone call ending due to the child account having insufficient funds to continue the phone call.

The present solution includes several advantages. First, the solution alleviates many issues related to coordinating multiple communications debiting a balance at once, allowing for a simple and elegant implementation of accounting logic. Second, the solution allows tracking, management, and configuration of individual accounts while allowing the accounts to pull from a common parent account balance. For example, each child account may be configured with different preferences related to the communications services. The preferences may include, but are not limited to, separate conference bridges using the same parent account, accountability/tracking reports, speed dial configurations, or any other suitable preferences. In addition, because recharges for the child accounts may occur via the parent account, credit card configurations related to recharge may be stored in the parent account, and need not be configured for each individual child account.

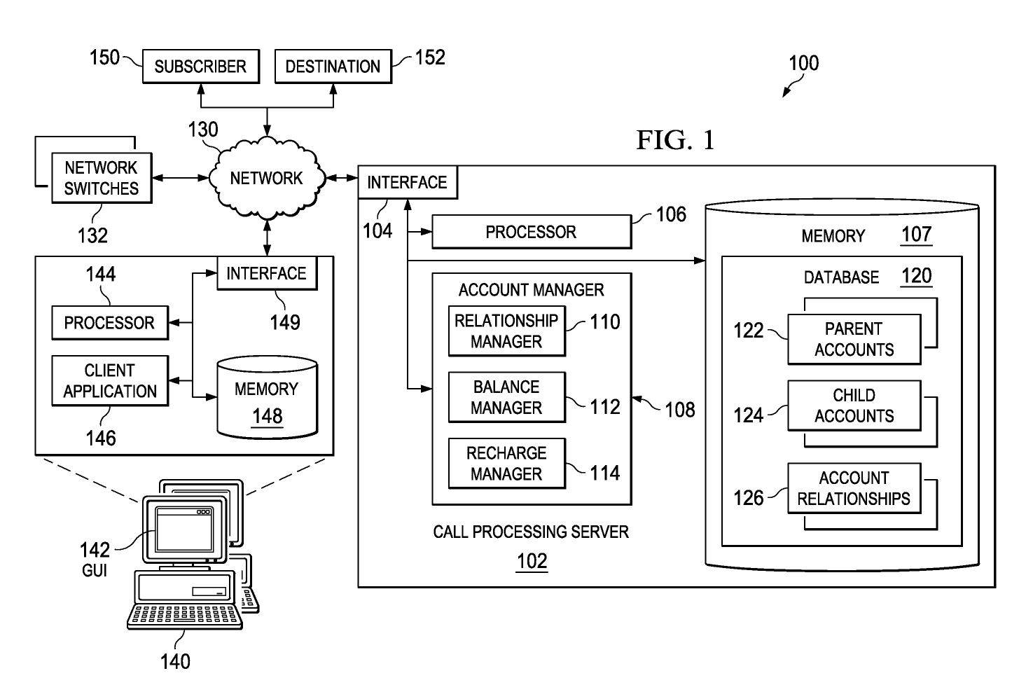

FIG. 1 shows an example environment 100 for enabling a parent-child account relationship. The example environment 100 includes a call processing server 102, a client 140, one or more network switches 132, a subscriber 150, and a destination 152. In the illustrated implementation, a network 130 connects the various components.

In operation, subscriber 150 may initiate a communication to one of the one or more network switches 132 via the network 130. Subscriber 150 may enter account information to identify the account to charge for the associated communication. The indication may be sent from the network switches 132 to call processing server 102, where it may be interpreted by the account manager 108. The account manager 108 may consult the database 120 determine whether the account denoted by the account information is a child account associated with a parent account. If the account information is associated with a child account, the account manager 108 may transfer a certain amount of funds from the parent account associated with the child account to be used for the present communication. In some implementations, the amount to transfer may be preconfigured, or the amount may be computed based on attributes of the communication, such as the intended destination, the rate associated with the communication, or other attributes.

Once the funds are transferred from the parent account to the child account, the account manager 108 may indicate to the subscriber 150 the balance now associated with the child account. The communication requested by the subscriber 150 may then proceed. When the communication finishes, the account manager 108 may receive an indication that the communication has ended. The account manager 108 may then transfer any remaining funds from the child account to the parent account, such that the child account is left with a nominal or zero balance at the conclusion of the communication.

In some cases, the initial amount transferred from the parent account to the child account may not be sufficient for the entire communication. If the transferred balance is completely used and the communication is still ongoing, the account manager 108 may transfer additional funds from the parent account to the child account for use by the communication. In some implementations, this “recharge” functionality may be executed when the balance associated with the child account reaches a certain threshold, when the amount of time remaining for the communication based on the balance of the child account reaches a certain threshold, or any other suitable condition.

As shown in FIG. 1, the environment 100 includes a call processing server 102. In the depicted implementation, the call processing server 102 is a data processing apparatus that may include various components for providing communications service, including an interface 104, a processor 106, and an account manager 108.

The interface 104 may be used by the call processing server 102 for communicating with other systems in a distributed environment—including within the environment 100—connected to the network 130; for example, the client 140, as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated environment 100.

The call processing server 102 may include a processor 106. In some cases, the processor 106 directs the operation of the other components of the call processing server 102 by executing the software instructions making up these various components. In some cases, the processor 106 may include multiple physical central processing units (CPUs) which may be contained inside a single chassis or distributed across multiple computers and connected via a network or backplane. In some cases, the processor 106 may be a general purpose processor such as those produced by INTEL, AMD, HP, ARM, APPLE, or any other suitable processor. The processor 106 may also be a custom application specific integrated circuit (ASIC) or field programmable gate array (FPGA) specifically adapted to the present application.

In the illustrated implementation, call processing server 102 includes an account manager 108. In some implementations, the account manager may be operable to perform accounting operations during a communication handled by the call processing server 102. For example, if the subscriber 150 makes a telephone call to the destination 152 through one of the one or more network switches 132, the telephone call will accrue a certain amount of charges based on how the subscriber's account is configured. The account manager 108 may keep track of the charges accrued during the communication, and debit a balance associated with the subscriber's account as the communication proceeds. In some implementations, the account manager 108 may be a software program or collection of software programs running on the call processing server 102. The account manager 108 may also be a software program running on a separate server from the call processing server communicating with the call processing server 102 via the network 130. The account manager 108 may also be implemented in hardware, or a combination of hardware and software.

As shown, the account manager 108 may include a relationship manager 110. In some implementations, the relationship manager 110 may be operable to determine a relationship between a child account and a parent account. The relationship manager 110 may make this determination by consulting the database 120, specifically the account relationships 126. For example, if the subscriber 150 enters an account number of “12345” at the beginning of the communication, the relationship manager 110 may consult the database to determine whether the account associated with account number “12345” has an associated parent account. In some implementations, the relationship manager 110 may determine whether an account is associated with the parent account by querying the database 120 using Structured Query Language (SQL), or any other suitable query language supported by the database 120.

In some implementations, the relationship manager 110 may enforce characteristics on the parent and child accounts stored in the database 120. For example, a parent account may not be permitted to be used to initiate communications in some cases. In such a case, the relationship manager 110 may detect that the provided account is a parent account, and may reject the request to start the communication.

The account manager 108 may also include a balance manager 112. In operation, the balance manager 112 may transfer a portion of the balance from a parent account to a child account at the beginning of the communication associated with the child account. For example, the communication is to be initiated on child account “12345,” the balance manager 112 may reduce the balance with a parent account by a configured amount, and increase the balance associated with the child account by that same amount. In some implementations, the balance manager 112 may insert a transaction record into a table in the database 120 to indicate that such transfer has been made. In some cases, the balance manager 112 may consult a configuration table to determine the amount to transfer from the parent account to the child account. The balance manager 112 may also determine the amount to transfer from the parent account to the child account based on characteristics associated with the requested communication. For example, if the requested communication has an associated rate of ten cents a minute, the balance manager 112 may be configured to provide the child account with sufficient funds for a ten minute communication. In such a case, the balance manager 112 may transfer one dollar (sufficient funds for ten minutes of talk time at a ten cents per minute rate) from the parent account to the child account.

In some implementations, the balance manager 112 may also be operable to transfer any remaining funds from the child account to the parent account when a communication ends. For example, the communication associated with a rate of ten cents per minute ends after nine minutes, a balance of ten cents will be left on the child account. The balance manager 112 may transfer this remaining ten cents from the child account to the parent account, such that the child account is left with a zero balance at the end of the communication. In some implementations, the child account may be left with a nominal balance (e.g. one cent) at the end of the communication. The balance manager 112 may also insert a transaction record into the database 120 to indicate that this end of call transfer has occurred.

As shown, the account manager 108 also includes a recharge manager 114. The recharge manager 114 may be operable to detect the child account associated with the communication has had its balance fall below a configured threshold. The recharge manager 114 may then initiate a transfer of funds from the parent account to the child account for use in the associated communication. For example, if a child account is associated with a communication with a rate of ten cents per minute, and the balance of the child account is ten cents, the recharge manager 114 may detect that the child account has one minute of talk time remaining. If this amount of talk time is below a configured threshold, the recharge manager may transfer a configured amount of funds from the parent account to the child account. For example, recharge manager 114 may debit the parent account by one dollar and add one dollar to the child account. The recharge manager may perform this process multiple times during a given communication if the child account balance falls below the configured threshold multiple times—in some implementations, the recharge manager 114 may insert transaction record in the database 120 to indicate that a transfer has occurred from the parent to child.

The call processing server 102 may also include a memory 107 for storing a database 120. The database 120 may include several different databases hosted on different servers connected via local area network or a public network such as the Internet. In such a configuration, the component databases of database 120 may be interconnected by a replication mechanism that keeps the component databases in sync. In some implementations, the component databases may be exact replicas of each other, while in other implementations only a portion of the databases may be replicated. The database 120 may be provided and managed by a database management system (DBMS) including, but not limited to, ORACLE, INFORMIX, DB2, SQL SERVER, MYSQL, POSTGRES, SQLITE, VERTICA, or any other suitable DBMS. In some cases, the various data items stored by database 120 may be stored in separate relational tables, while in other cases the data items may be stored in individual rows inside a table, in columns inside a table, across various tables, more than one data item in a single table, or in any other suitable configuration. The database 120 may also store additional configuration related to the other components of the call processing server 102, which may access the database 120 to retrieve this information and the data items specifically described herein.

As shown, the database 120 may include one or more parent accounts 122, and one or more child accounts 124. In some implementations, the parent accounts 122 and the child accounts 124 may be included as records inside a single or multiple database tables. In some cases, the parent accounts 122 and the child accounts 124 may share a common structure or format, such that the two are differentiated by attributes stored in the table, or by attributes stored in another table. For example, a parent account 122 and a child account 124 may differ based on a type attribute that indicates that the parent account is a parent of the child account. In some cases, the parent accounts 122 and child accounts 124 are differentiated by the account relationships stored in the account relationships table 126.

In some implementations, the parent accounts 122 may include one or more identifiers usually identifying the account, such as an account number or personal identification number (PIN). The parent accounts 122 may also include a balance associated with the account in some cases which may be stored as a numeric value indicating a monetary amount, such as amount of cents, dollars, or other monetary.

In some implementations, the database 120 may include child accounts 124. In some cases, the child accounts 124 include information related to the account, such as a PIN, a balance, statistics related to the usage of the account, and other settings related to the account. In some cases, the child accounts 124 may include a type field that indicates that the child account 124 is a child account.

As shown, the database 120 also includes one or more account relationships 126. In some implementations, the account relationships 126 may be rows inside a table separate from the parent accounts 122 and child accounts 124. The account relationships 126 may include an indication of a parent account and associated child account. In some cases, the account relationships 126 may include a unique identifier for the parent account in the child account, such as an account number or PIN. Account relationships 126 may also include additional attributes or settings associated with the relationship, such as, for example, an amount associated with each transfer from the parent to child account, a recharge threshold indicating when to perform additional transfers from parent to the child account during a communication, an indication of an end of communication behavior associated with the relationship, or any other suitable attributes.

The environment 100 may also include one or more network switches 132 communicatively coupled to network 130. In some cases, the network switches 132 may be standard telecom equipment used to connect time slots or ports together to complete telephone calls. The network switches 132 may also be voice over internet protocol (VOIP) equipment operable to service telephone calls originating and/or terminating to IP networks. The network switches 132 may be commercially available networking equipment including products manufactured by ALCATEL-LUCENT, CISCO, NORTEL, HP, STRATUS or any other suitable switching product. The network switches 132 may also include general purpose routers, multiplexers, gateways, or other equipment. In some cases, the network switches 132 may be controlled by the call processing server 102 via one or more APIs. The APIs may be standard protocols such as SIP or H.323, proprietary control protocols specific to the manufacturer of the network switch, or any other suitable API or combination of APIs.

The environment 100 may also include a subscriber 150. In some cases, the subscriber 150 may be a person associated with one of the parent accounts 122 or the child accounts 124. The subscriber 150 may access the call processing server 102 by an access number on an associated telephone. The subscriber 150 may also access the call processing server 102 by connecting to an IP address associated with the call processing server 102 or one of the network switches 132. In some instances, the subscriber 150 may access the call processing server 102 or network switches 132 using a software application configured to communicate with these components. The call processing server 102 may provide a service to the subscriber 150. For example, the call processing server 102 may provide a prepaid calling service to the subscriber 150, in which the call processing server 102 prompts the subscriber 150 for an account number or PIN, prompts the subscriber 150 for a destination number to connect to, and then tracks the charges accrued for the talk time associated with the call and debits the balance of an associated account accordingly. In some cases, the call processing server 102 may interact with the one or more network switches 132 to connect subscriber 150 to a destination 152. In some cases, destination 152 may be another subscriber of the call processing server 102. The destination 152 may also be any telephone or other communications device, and may be identified by a destination entered by the subscriber 150.

The environment 100 may also include a client 140 that includes a GUI 142. The client may include an interface 149, a processor 144, a memory 148 and a client application 146. The client 140 may be used by an administrator or a subscriber to access the call processing server 102 in order to view or change the various data items stored in database 120, view or change reports generated from the data items in the database 120, make calls or perform any other suitable function.

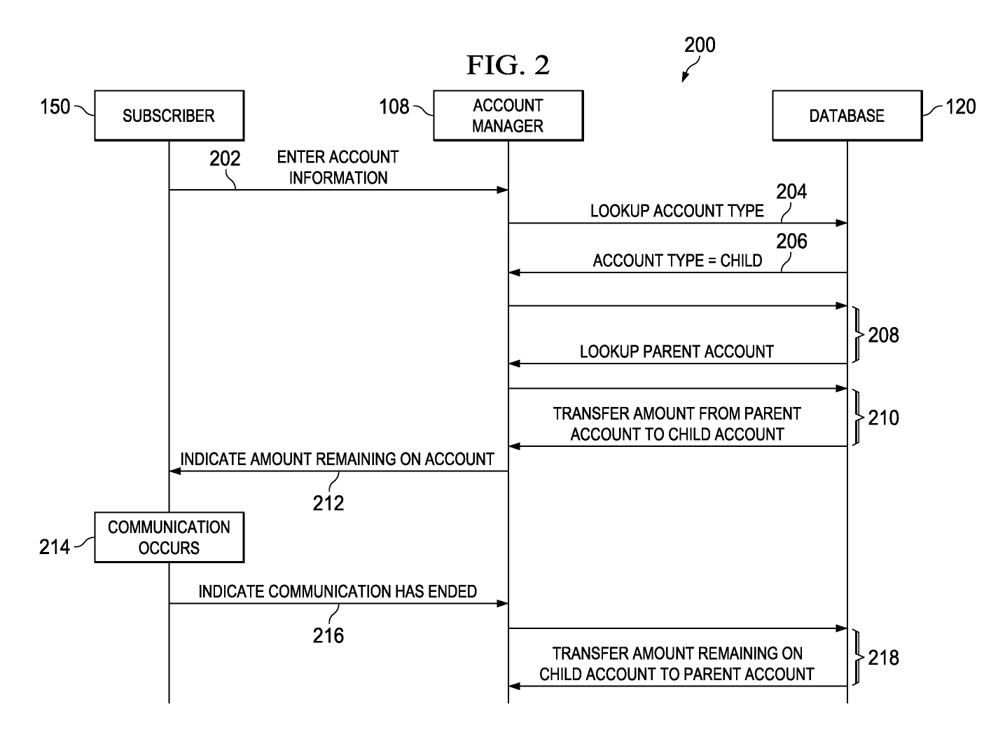

FIG. 2 shows an example interaction 200 for enabling a parent-child account relationship. Example interaction 200 occurs between the subscriber 150, the account manager 108, and the database 120 described relative to FIG. 1. At 202, subscriber 150 enters account information which is sent to the account manager 108. In some implementations, the subscriber 150 may enter account information, such as account number or PIN, at the beginning of the communication to indicate the account to be charged for the communication. In some implementations, entering the account information may include typing the account number on a touchtone keypad of the telephone, speaking the account number into the telephone, or any other suitable mechanism for entering the account information. In some cases, the account information may be entered by the subscriber by performing an application programming interface (API) call to the call processing server 102, or to another component within the environment 100. Although the interaction 200 shows the subscriber 150 entering the account information directly into the account manager 108, the account information may be forwarded from another component or components within the environment 100 to the account manager 108.

At 204, the account manager 108 looks up the account type of the account associated with the account information in the database 120. In some implementations, the account manager 108 may issue an SQL query to the database 120 to lookup the account type associated with the account. In some cases, the account manager 108 may query an account record that includes the account type. The account manager 108 may also query a separate record from the account record, such as the account relationships 126, in order to determine the account type.

At 206, database 120 returns an indication that the type of account associated with the account information is a child account. In some cases, the account may be designated as a child account by the inclusion of a row associated with the account in the account relationships 126. The account may also be indicated as a child account by a value in a type field in the account record.

At 208, the account manager looks up the parent account for the account associated with the entered account information in the database 120. In some implementations, looking up the parent account includes reading a parent account number from the account relationships 126, and querying an account table for the parent account.

At 210, the account manager 108 instructs a database to transfer an amount from the parent account to the child account. In some implementations, the account manager 108 may consult a separate configuration table or resource to determine the amount to transfer from the parent account to the child account. In some cases, the amount transferred may be based on a destination associated with the request of communication. For example, if the requested communication is associated with the destination of Vietnam, the communication may be associated with a higher rate than the communication associated with United States. In such a case, the account manager 108 may transfer a larger amount from the parent account to the child account for a communication associated with Vietnam than for a communication associated with United States. In some implementations, the amount to transfer is based on a rate associated with the communication. In some cases, the amount of transfer is based on a configuration associated with the relationship, or with the parent or child account.

At 212, the account manager 108 indicates an amount remaining on the account to the subscriber 150. In some implementations, the account manager may send a message to another component within the environment 100 instructing the component to indicate the amount remaining to the account subscriber. For example the account manager 108 may use an API to control an interactive voice response (IVR) to speak an amount in dollars and cents corresponding to the amount remaining on the child account. In some implementations, the account manager may return this amount remaining to the subscriber in response to an API call requesting initiation of the communication. At 214, the communication requested by the subscriber 150 occurs. In some implementations, the communication occurring may include subscriber 150 having a telephone conversation with the destination 152. The communication occurring may also include the subscriber 150 participating in a conference call with other subscribers. Communication occurring may also include subscriber 150 making a voice over IP (VOIP) call to a destination 152 over an IP network such as the Internet. The communication occurring may also include other types of electronic communication, such as email, file transfers, text messages, or any other suitable type of communication.

At 216, subscriber 150 indicates to the account manager 108 that the communication has ended. As discussed previously, although the interaction 200 detects this indication is occurring directly between the subscriber 150 and the account manager 108, the indication may be forwarded through many different components between the subscriber 150 and the account manager 108. For example, the subscriber 150 may indicate the communication has ended by hanging up a telephone receiver at the end of the telephone call.

At 218, the account manager 108 transfers an amount remaining on the child account to the parent account. In some implementations, the account manager 108 will transfer the entire remaining balance on the child account back to the parent account when the communication ends. In some cases, the account manager 108 may leave a nominal amount such as one cent on the child account at the conclusion of communication. The amount to be left on the child account at the end of the communication by the account manager 108 may be configured within the database 120.

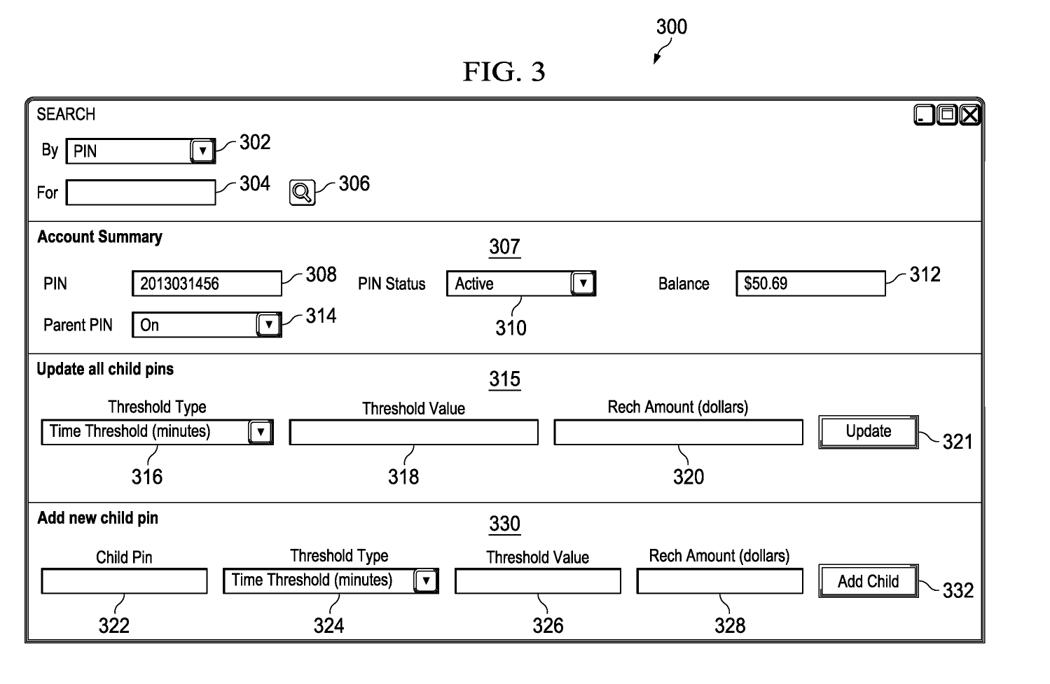

FIG. 3 shows an example interface 300 for configuring a parent account. The example interface 300 includes a search type drop-down 302, an account search box 304, and a search button 306. These components are operable to allow a user to enter an account number or PIN and search for information about that account by pressing the search button 306.

The interface 300 also includes an account summary tab 307 to display information related to the selected account. The account summary tab 307 includes information related to the account retrieved in response to the search. The account summary 307 includes a PIN 308, a PIN status 310, a balance 312, and a parent PIN indicator 314. The parent PIN indicator 314 shows that the present PIN is a parent PIN by displaying the text “on”.

The interface 300 also includes an update tab 315. A user of the interface 300 may use the update tab 315 to change attributes associated with all child accounts associated with the parent accounts. As shown, the update tab 315 includes a threshold type drop down box 316, from which the user can select the type of threshold that should be used when transferring funds from the parent account to the child account. For example, the threshold type drop down box 316 indicates that a time threshold should be used, such that when a certain amount of time is remaining on the account, a transfer from the parent account to the child accounts should be initiated. For example, if the communication is active and the balance on the child account has dropped to a level where the communication may only continue for another minute, a transfer from the parent account to the child account may be initiated if this amount remaining is below the configured threshold. The update tab 315 also includes a threshold value 318 that may be used to set the threshold at which a transfer from the parent account of the child account will occur. The update tab 315 also includes a recharge amount field 320 into which the amount to be transferred from the parent account to the child account may be entered. To perform the update specified by the update tab 315, the user may activate the update button 321.

The example interface 300 also includes an add child PIN tab 330. As shown, the add child PIN tab 330 includes a child PIN field 322, a threshold type drop down 324, a threshold value field 326, and a recharge amount field 328. Users of the interface 300 may use these fields to indicate a child account to be associated with the current parent account, as well as the attributes to be associated with that child account. The add child PIN tab 330 also includes an add child button 332 that the user may activate in order to add the specified account as a child and set the specified attributes.

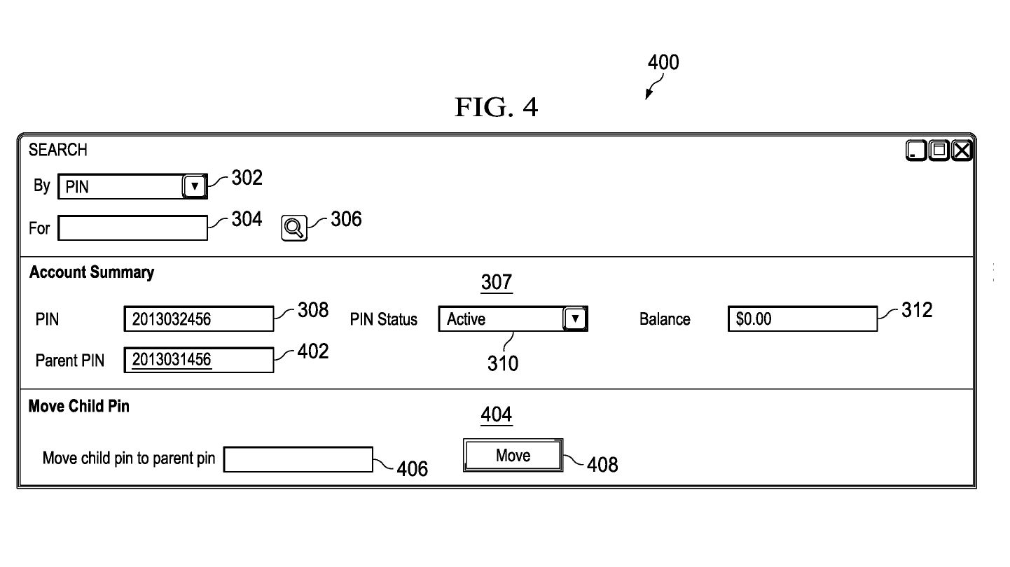

FIG. 4 shows an example interface 400 for configuring a child account. Example interface 400 includes the search fields 302, 304 and 306 described relative to FIG. 3. The example interface 400 also includes an account summary 307 including the PIN field 308, the PIN status drop-down 310, and the balance field 312. All described in FIG. 3. The account summary 307 also includes a parent PIN field 402. As shown, the PIN field 402 displays the account number or PIN of the parent account for the selected child.

Example interface 400 also includes a move child PIN tab 404. The move child PIN tab 404 includes a new parent PIN field 406, into which the user may enter the account number or PIN of a new parent account to associate this child account to. The move child PIN tab 404 also includes a move button 408 that the user may activate to perform the move operation.

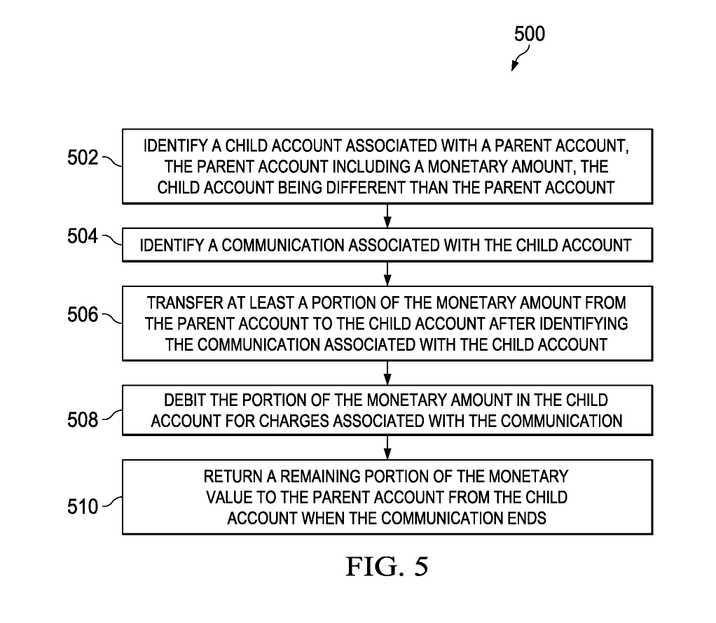

FIG. 5 shows an example method 500 for enabling a parent-child account relationship. For clarity of presentation, the description that follows generally describes method 500 in the context of FIG. 1. However, it will be understood that method 500 may be performed, for example, by any other suitable system, environment, software, and hardware, or a combination of systems, environments, software, and hardware, as appropriate. For example, one or more of the database server, the client, or other computing device (not illustrated) can be used to execute method 500 and obtain any data from the memory of the client, the database server, or the other computing device (not illustrated).

At 502, a child account associated with the parent account is identified, the parent account including a monetary amount, the child account being different than the parent account. In some implementations, identifying the child account includes querying a database to determine an associated parent account for a child account. In some cases, the monetary amount included in the parent account may be a dollar amount that has already been charged to the owner of the account, such as via credit card or other transaction. In some implementations, the monetary amount may be a prepaid monetary amount. The monetary amount may also be a credit limit.

At 504, a communication associated with the child account is identified. In some implementations, the communication may be a telephone call placed between a subscriber and a destination. The communication may also be a conference call between multiple subscribers. The communication may also include a form of electronic communication, such as, for example, email, text or SMS, or any other suitable form of communication.

At 506, at least portion of the monetary amount is transferred from the parent account to the child account after identifying the communication associated with the child account. In some implementations, transferring at least a portion of the monetary amount includes executing a database query to debit a balance associated with the parent account by a certain amount and credit the child the balance associated with the child account by the same amount. In some cases, a transaction record may be written to the database to indicate that this transfer has occurred.

In some implementations, the transfer at 506 may occur at multiple times during the duration of the communication, such as when the amount or time remaining on the child account falls below a threshold. In some cases, if the transfer at 506 is attempted and the parent account does not have sufficient funds for the transfer to occur, additional funds may be added to the parent account by charging an associated credit card, transferring funds from another account, or by any other suitable mechanism.

At 508, the portion of the monetary amount in the child account is debited for charges associated with the communication. For example, if the communication is a telephone call associated with a rate of ten cents per minute, the monetary amount associated with the child account will be debited ten cents for every minute the communication continues.

At 510, a remaining portion of the monetary amount is returned to the parent account from the child account when the communication ends. In some implementations, returning the remaining portion of the monetary amount to the parent account from the child account includes executing an SQL query against a database that debits the amount remaining on the child account by a certain amount and credits the amount remaining on the parent account by that same amount. In some cases, the entire monetary amount remaining on child account is returned to the parent account at the end of the indication. A portion of the monetary amount remaining on the child account may also be left on the child account when the communication ends. The amount that should be left on the child accounts when the communication ends may be configured based on the parent-child relationship.

In some implementations, the child account may include a nominal monetary amount when not associated with a communication. For example, the child account may be left with a monetary value of 2 cents after the communication ends and the remainder of the monetary amount is transferred back to the parent account.

In some cases, the parent account may be associated with a plurality of child accounts, and two or more of the child accounts associated with the parent may be used in communication simultaneously.

Purchase of an additional monetary amount may be initiated upon the monetary amount of the parent account reaching a value less than a threshold value. In some cases, initiating the purchase may include initiating a credit card transaction for a configured amount using stored credit card information associated with the parent account.

In some instances, the child account may be disassociated from the parent account, after which the child account may maintain a separate monetary amount from the parent account. The disassociation may be performed by updating a database table, such as by deleting a row specifying that the child account is associated with the parent account. In some cases, the child account may be used for communication after disassociation in a similar manner as it was used prior to disassociation, with a difference being that the child account will assess charges associated with the communication from its monetary amount and will not interact with the parent account. The disassociated child account will not receive a transfer of a monetary amount from the parent account at the beginning of the communication, and will not return an unused portion of the monetary amount to the parent account at the end of the communication.

In some cases, the parent account may be configured to be used in communications upon determination that the parent account is not associated with any child accounts. For example, an administrator may activate an option within an interface to enable the parent account to be used in communications, causing a database record associated with the parent account to be updated. After such configuration, a user may initiate a communication using the parent account in the same manner as any other account.

In some cases, it may be determined that the monetary amount in the child account is below a threshold, and an additional portion of the monetary amount from the parent account may be transferred to the child account upon determining that the monetary amount in the child account is below the threshold.

As previously discussed, the child account may be associated with configuration information separate from configuration information associated with the parent account, including, but not limited to, a speed dial configuration indicating phone numbers that may be dialed using a shortened series of digits, a language configuration indicating a language in which the account holder prefers to hear voice prompts, a billing configuration indicating how the child account will be charged for communications usage, or a branding configuration indicating branding messages to play during communications using the child account. The child account configuration information may also be separate from configuration information associated with other child accounts, such that each child account may have its own configuration information.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program, by way of example, can be based on general or special purpose microprocessors or both or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including, by way of example, semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

1. A computer-implemented method executed by one or more processors, the method comprising:
identifying, by the one or more processors, a child account associated with a parent account, the parent account including a monetary amount, the child account being different than the parent account;
identifying, by the one or more processors, a call associated with the child account;
in response to identifying the call associated with the child account, transferring, by the one or more processors, at least a portion of the monetary amount from the parent account to the child account;
in response to transferring at least a portion of the monetary amount from the parent account to the child account, identifying, by the one or more processors, charges associated with the call;
in response to identifying charges associated with the call, debiting, by the one or more processors, the portion of the monetary amount in the child account for the charges associated with the call; and
automatically returning a remaining portion of the monetary amount to the parent account from the child account after debiting the portion of the monetary amount in the child account for the charges associated with the call.

2. (canceled)

3. The method of claim 1, wherein the child account includes a nominal monetary amount when not associated with a call.

4. The method of claim 1, wherein the parent account is associated with a plurality of child accounts.

5. The method of claim 4, wherein two or more of the plurality of child accounts associated with the parent account are simultaneously associated with calls.

6. The method of claim 1, further comprising initiating a purchase of an additional monetary amount upon the monetary amount of the parent account reaching a value less than a threshold value.

7. The method of claim 1, further comprising:
disassociating the child account from the parent account, wherein the child account maintains a separate monetary amount from the parent account after disassociation and can be used for calls after disassociation.

8. The method of claim 7, further comprising:
determining that the parent account is not associated with any child accounts; and
configuring the parent account to be used in calls upon determination that the parent account is not associated with any child accounts.

9. The method of claim 1, further comprising:
determining that the monetary amount in the child account is below a threshold; and
transferring an additional portion of the monetary amount from the parent account to the child account upon determining that the monetary amount in the child account is below the threshold.

10. The method of claim 1, wherein the child account is associated with configuration information separate from configuration information associated with the parent account.

11. The method of claim 10, wherein the configuration information includes at least one of: a feature configuration, a language configuration, a billing configuration, or a branding configuration.

12. The method of claim 1, wherein the monetary amount is a credit limit.

13. The method of claim 1, wherein the monetary amount is a prepaid monetary amount.

14. A non-transitory, computer-readable medium storing instructions operable when executed to cause at least one processor to perform operations comprising:
identifying a child account associated with a parent account, the parent account including a monetary amount, the child account being different than the parent account;
identifying a call associated with the child account;
in response to identifying the call associated with the child account, transferring at least a portion of the monetary amount from the parent account to the child account;
in response to transferring at least a portion of the monetary amount from the parent account to the child account, identifying charges associated with the call;
in response to identifying charges associated with the call, debiting the portion of the monetary amount in the child account for the charges associated with the call; and
automatically returning a remaining portion of the monetary amount to the parent account from the child account after debiting the portion of the monetary amount in the child account for the charges associated with the call.

15. (canceled)

16. The computer-readable medium of claim 14, wherein the child account includes a nominal monetary amount when not associated with a call.

17. The computer-readable medium of claim 14, wherein the parent account is associated with a plurality of child accounts.

18. The computer-readable medium of claim 17, wherein two or more of the plurality of child accounts associated with the parent account are simultaneously associated with calls.

19. The computer-readable medium of claim 14, further comprising initiating a purchase of an additional monetary amount upon the monetary amount of the parent account reaching a value less than a threshold value.

20. A system comprising:
memory for storing data; and
one or more processors operable to perform operations comprising:
identifying a child account associated with a parent account, the parent account including a monetary amount, the child account being different than the parent account;
identifying a call associated with the child account;
in response to identifying the call associated with the child account, transferring at least a portion of the monetary amount from the parent account to the child account;
in response to transferring at least a portion of the monetary amount from the parent account to the child account, identifying charges associated with the call;
in response to identifying charges associated with the call, debiting the portion of the monetary amount in the child account for the charges associated with the call; and
automatically returning a remaining portion of the monetary amount to the parent account from the child account after debiting the portion of the monetary amount in the child account for the charges associated with the call.

21. The method of claim 1, wherein the monetary amount transferred from the parent account to the child account is a preconfigured amount.

22. The method of claim 1, wherein the monetary amount transferred from the parent account to the child account is determined based at least in part on attributes of the communication including at least one of a monetary rate to be charged for the communication, or an intended destination of the communication.

23. The method of claim 1, wherein transferring at least a portion of the monetary amount from the parent account to the child account includes updating a parent account record associated with the parent account to debit a monetary balance associated with the parent account by the transferred monetary amount and updating a child account record associated with the child account to credit a monetary balance associated with the child account by the transferred monetary amount.

24. The method of claim 23, wherein the child account record and the parent account record are linked by common attributes within a database storing both account records.

25. The method of claim 1, wherein identifying charges associated with the call includes:
determining a monetary rate for the call based on an address associated with the call indicating an intended destination for the call;
connecting the call to the intended destination indicated by the address;
detecting that the call has disconnected from the intended destination;
in response to detecting that the call has disconnected from the intended destination, determining a duration for the call; and
determining at least a portion of the charges associated with the call by multiplying the duration for the call by the determined monetary rate.

26. The method of claim 1, wherein identifying the call associated with the child account includes receiving a message from a communications network indicating that the call has been initiated, wherein the call is a telephone call and the communications network includes a plurality of computing devices.
